(19) United States
(12) Patent Application Publication
(10) Pub. No.: US 2025/0055411 A1
(43) Pub. Date: Feb. 13, 2025

(54) Modular Photovoltaic Sunshade

(71) Applicant: Oldcastle BuildingEnvelope, Inc., Dallas, TX (US)

(72) Inventors: Richard Braunstein, Addison, TX (US); Thomas Bougher, Dallas, TX (US); Philip M. Benes, Wausau, WI (US); William J. Lang, Rockwall, TX (US)

(73) Assignee: Oldcastle BuildingEnvelope, Inc., Dallas, TX (US)

(21) Appl. No.: 18/799,296

(22) Filed: Aug. 9, 2024

Related U.S. Application Data
(60) Provisional application No. 63/518,718, filed on Aug. 10, 2023.

(51) Int. Cl. H02S 20/32; E04F 10/00

(52) U.S. Cl. CPC H02S 20/32; E04F 10/005

(57) ABSTRACT

In a general aspect, a sunshade array includes a plurality of sunshade systems. Each sunshade system includes a frame system that is coupled to a building exterior. A photovoltaic panel is supported by the frame system. An electrical raceway is coupled to the plurality of sunshade systems. The electrical raceway contains an electrical coupling to an electrical system of the building for the photovoltaic panel contained in each sunshade system.

### CROSS-REFERENCE TO RELATED APPLICATIONS

This patent application claims priority to, and incorporates by reference, U.S. Provisional Patent Application No. 63/518,718, filed on Aug. 10, 2023 and titled “Modular Photovoltaic Sunshade.”

### BACKGROUND

The following description relates to a modular photovoltaic sunshade.

With movement toward net-zero energy buildings (NZEB), opportunities are being sought to reduce a building's energy consumption as well as opportunities to generate onsite electricity. The geometry of a sunshade, designed and positioned on a building to reduce solar heat gain, is often optimally positioned to harvest the solar radiation should a photovoltaic panel be placed on the top surface of the sunshade device.

Standard commercial sunshade systems are not designed to economically accommodate photovoltaic (PV) panels. In particular, sunshade systems have not addressed the additional burden and complexity that comes with the wire management requirements for photovoltaic panels. Likewise, no standard sunshades have had to address the issues associated with efficiently repairing and or replacing photovoltaic modules or any of the respective balance of systems hardware.

### DESCRIPTION OF DRAWINGS

FIG. 1 is a perspective view of an example building exterior.

FIG. 2A is a top view of an example sunshade assembly illustrating an anchor.

FIG. 2B is a detailed perspective view of the example sunshade assembly and anchor.

FIG. 3 is a bottom view of the example building exterior including a sunshade system with a wire access door in an open position.

FIG. 4A is a plan view of an example sunshade array with a wire management raceway.

FIG. 4B is a plan view of the example sunshade array of FIG. 4A illustrating an electrical connection.

FIG. 5 is a side view of an example photovoltaic sunshade system illustrating an electrical raceway.

FIG. 6 is a detailed view of an example electrical raceway illustrating an access cover in an open position.

FIG. 7 is a view of an example electrical raceway illustrating decoupling of the electrical raceway from a frame system.

FIG. 8A is a top view of a photovoltaic array illustrating removal of a sunshade and frame system from support brackets.

FIG. 8B is a bottom view of an example photovoltaic array illustrating removal of a sunshade assembly.

FIG. 8C is a cross sectional view illustrating connection of a frame system to the support brackets.

FIG. 9 is a flow diagram illustrating an example process for installing a modular photovoltaic sunshade array.

### DETAILED DESCRIPTION

Exterior wall systems such as curtain walls and window walls are frequently utilized in architecture and construction projects. A curtain wall is one type of outer covering for a building that does not support the roof or floor loads. A curtain wall is generally installed over the exterior face of a building's intermediate floor slabs and, thus, allows for designs that minimize the space between adjacent rows of glass panels so as to present a more continuous exterior glass surface. Various types of curtain wall systems exist including, captured curtain-wall systems and structurally glazed curtain-wall systems. These systems generally include a network of curtain-wall members. The curtain-wall members often include horizontal members (e.g., horizontal mullions) and vertical members (e.g., vertical mullions) with panel members, often glass, disposed within the network. Window walls, in contrast, are secured between floor slabs and, thus, generally present a less continuous exterior glass surface.

In some aspects of what is described here, a modular sunshade is adapted for connection to a framing system for a building window system. In various embodiments, the window system could be, for example, a window wall system or a curtain wall system. In some instances, a modular sunshade system could be coupled to a building element adjacent to the framing system. The modular sunshade includes a photovoltaic panel mounted on an upper surface. A raceway is coupled to a frame of the sunshade. The raceway provides cable management and facilitates removal of a single photovoltaic panel for repair, replacement, cleaning, or preventative maintenance. In some instances, the sunshade assembly may be constructed to accommodate any angle of the photovoltaic panel relative to the outrigger. In some instances, this angle may be adjustable, for example, to optimize solar harvest or to optimize shading.

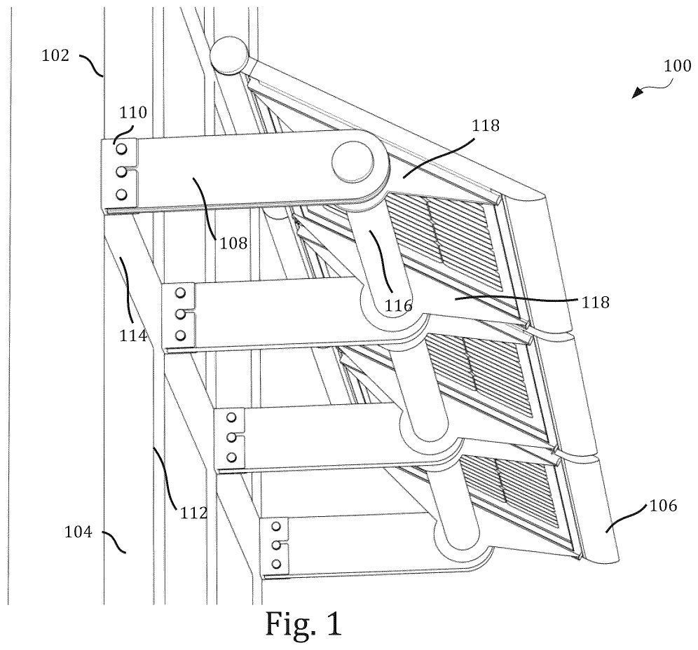

FIG. 1 is a perspective view of an example of a building exterior 100. The building exterior 100 includes a building exterior wall system 102 having several glazing panels 104 that are shaded by a sunshade assembly 106. The sunshade assembly 106 includes outriggers 108, which extend outwardly from the building exterior wall system 102. In various implementations, the building exterior wall system 102 may be, for example, a curtain-wall system, a window-wall system, or other type of wall system. A first end of the outrigger 108 is coupled to an anchor 110. The anchor 110 is coupled to structural components of the building exterior wall system 102 such as, for example, vertical mullions 112 or horizontal mullions 114. The anchor 110 facilitates coupling of the outrigger 108 to the building exterior wall system 102. A second end of the outrigger 108 is coupled to a support cross member 116. A pair of support brackets 118 are coupled to the support cross member 116. In various implementations, the pair of support brackets 118 may be arranged at any angle relative to the outrigger 108 so as to optimize solar harvest or to optimize shading. In some implementations, this angle may be adjustable.

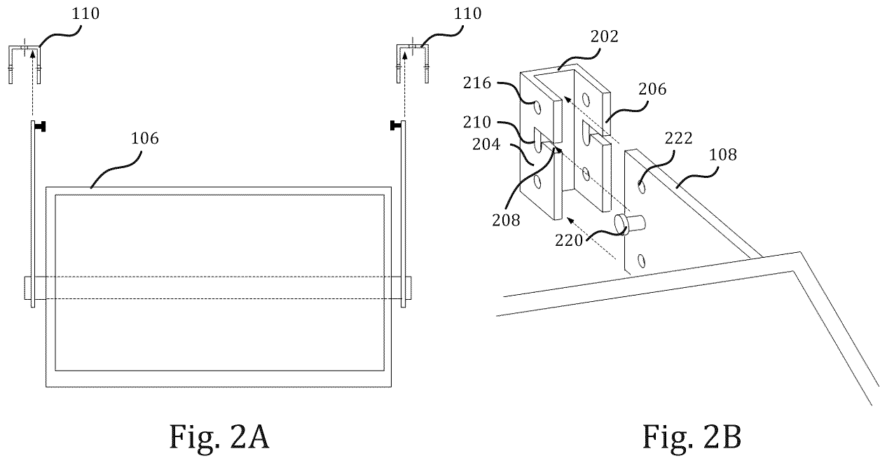

FIG. 2A is a top view of the sunshade assembly 106 illustrating coupling to the anchor 110. FIG. 2B is a detailed exploded perspective view of the anchor 110 illustrating an aspect of the sunshade assembly 106. In various implementations, the anchor 110 includes a back plate 202. A first flange 204 and a second flange 206 extend from the back plate 202. A notch 208 is formed in the first flange 204 and a groove 210 extends downwardly from the notch 208 in a generally perpendicular fashion. A first plurality of apertures 216 are formed in the first flange 204 and the second flange 206. In various implementations, the plurality of apertures 216 may receive, for example, threaded fasteners therethrough.

Referring to the examples illustrated in FIGS. 2A and 2B, a pin 220 extends inwardly from the outrigger 108 of the sunshade assembly 106. During assembly, the pin 220 is received into the notch 208 and rests in the groove 210. When the pin 220 is seated in the groove 210, apertures 222 that are formed in the outrigger 108 align in registry with the apertures 216 formed in the first flange and the second flange allowing receipt of, for example, a threaded fastener therethrough. Thus, during installation, the sunshade assembly 106 is supported by the interaction of the pin 220 and the groove 210 while the threaded fasteners are secured.

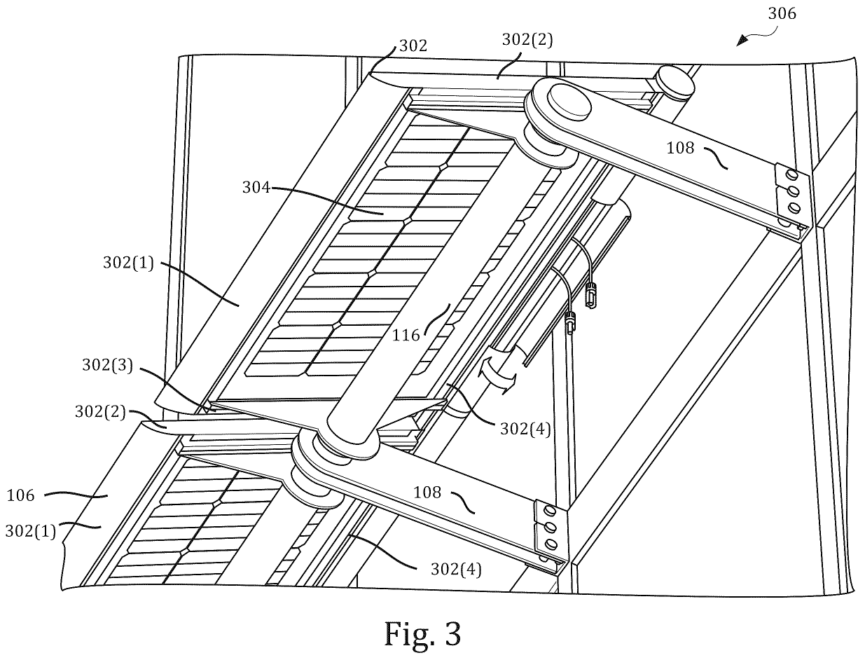

FIG. 3 is a bottom view of the example building exterior 100 including the sunshade assembly 106. As discussed above, the support cross member 116 is disposed between, and coupled to, a pair of outriggers 108. Each support cross member 116 is coupled to a pair of support brackets 118 (shown in FIG. 1). The support brackets 118 are coupled to respective parallel frame members of a frame system 302. The frame system 302 includes a first frame member 302(1), a second frame member 302(2), a third frame member 303(3), and a fourth frame member 302(4). In various implementations, the frame system 302 is formed, for example, from extruded aluminum; however, in other implementations, other materials may be utilized. The frame system 302 is coupled to, and supports, a photovoltaic panel 304. In various implementations, the photovoltaic panel 304 is mounted on a glass layer. In various implementations, the glass layer may be clear glass; however, in other arrangements could be utilized such as, for example, frosted glass, tinted glass, or glass having variable opacity such as switchable glass.

In various implementations, multiple sunshade assemblies 106 may be grouped together in series to form a sunshade array 306. In the example illustrated in FIG. 3, three sunshade assemblies 106 are grouped in a linear fashion with a single row to form the sunshade array 306; however, in other implementations, any number of sunshade assemblies 106 could be grouped together such as, for example, two sunshade assemblies 106, four sunshade assemblies 106, or five or more sunshade assemblies 106. Additionally, the sunshade array 306 may, in various implementations be non-linear. For example, the sunshade array could be curved, for example, to match an external curvature of a building. In still other implementations, the sunshade array 306 may include multiple rows of sunshade systems. In various implementations, the number of sunshade assemblies 106 that are grouped together into the sunshade array 306 may depend on several factors including, for example, a length of the building exterior wall system 102 as well as design and aesthetic characteristics of the building exterior wall system 102.

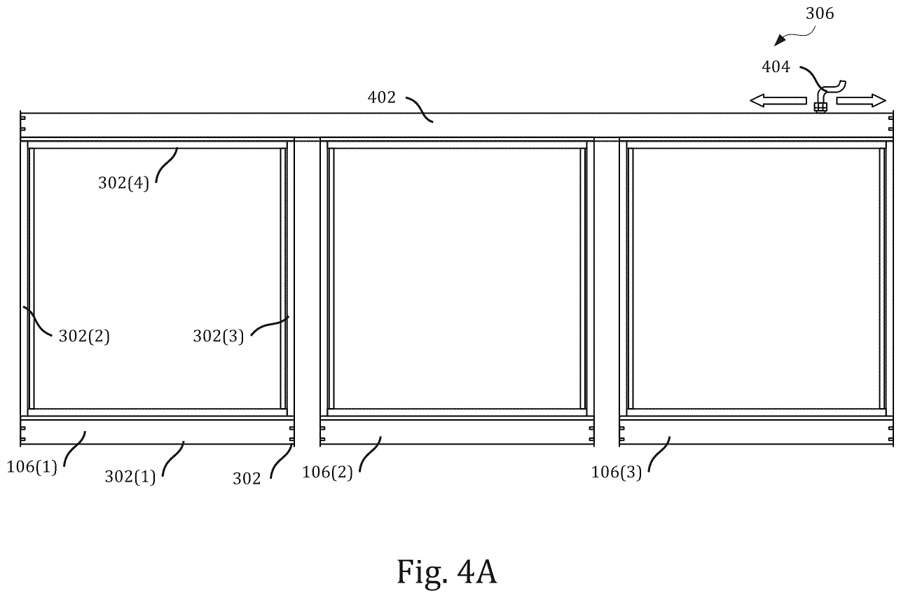

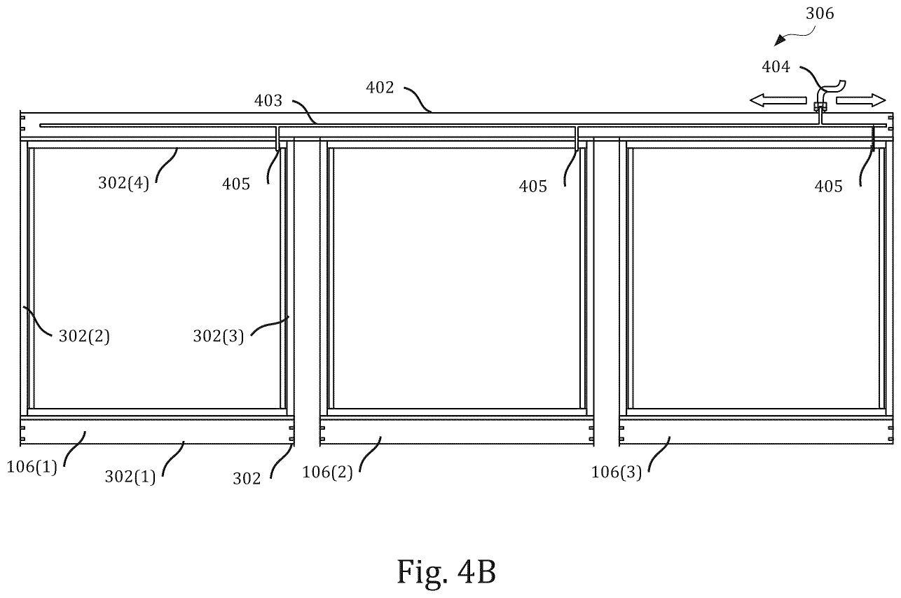

FIG. 4A is a plan view of an example sunshade array 306. The sunshade array 306 includes a plurality of sunshade assemblies 106. In the example shown in FIG. 4A, the sunshade array 306 includes three sunshade assemblies 106(1), 106(2), 106(3) arranged linearly; however, in other implementations, the sunshade array 306 may include any number of sunshade assemblies 106 including, for example, two, four, or five or more sunshade assemblies 106. Although the example sunshade array 306 is described in FIG. 4A as being linear, the sunshade array may, in other implementations be curved, for example, to match a curvature of an exterior building face.

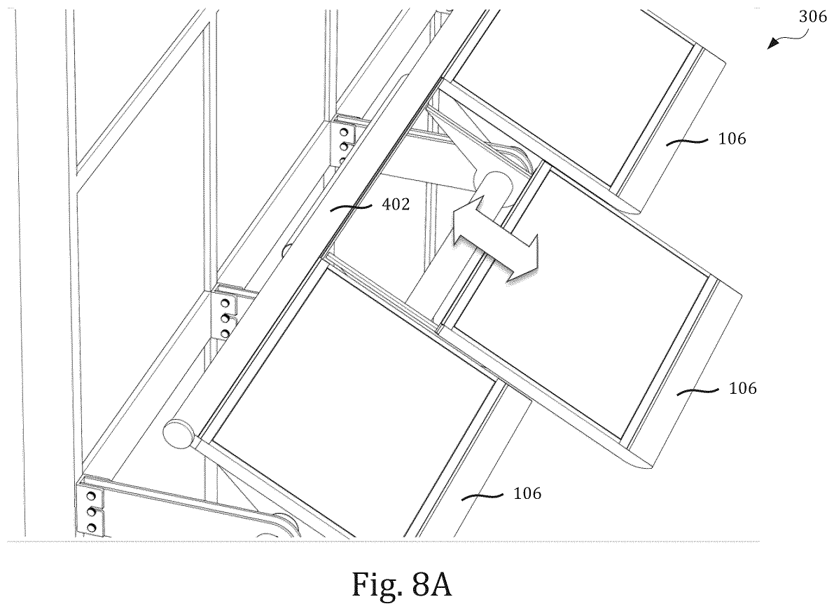

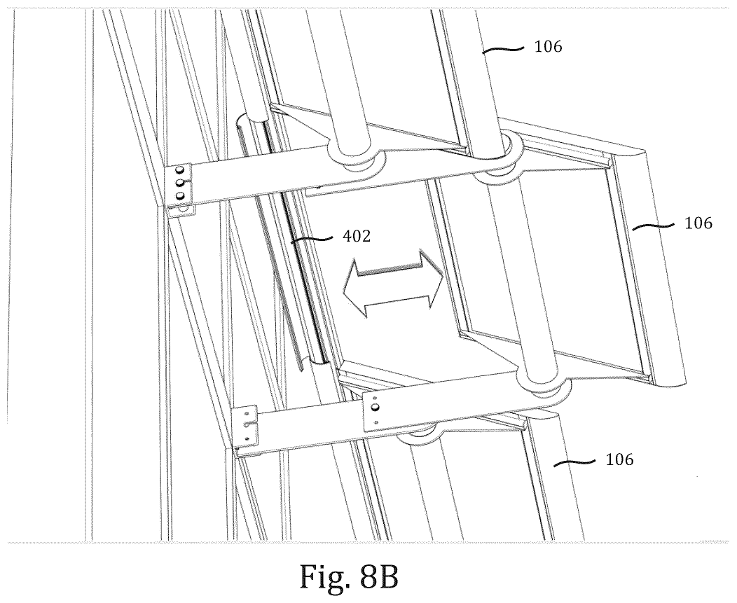

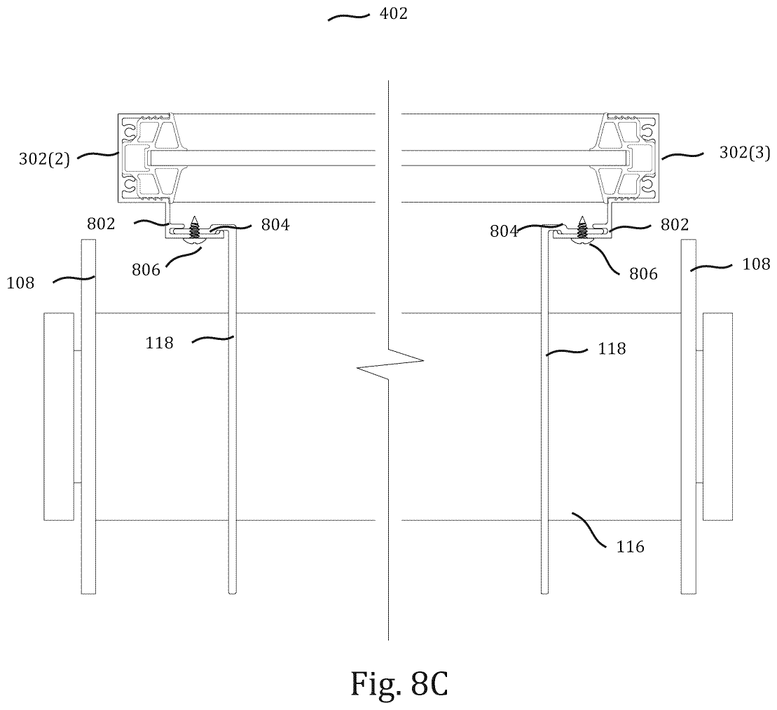

The sunshade assemblies 106 include the frame system 302. The frame system 302 includes a first frame member 302(1), a second frame member 302(2), a third frame member 303(3), and a fourth frame member 302(4). The frame system 302 is coupled to and supports a photovoltaic panel 304 (shown in FIG. 3). An electrical raceway 402 extends the length of the sunshade array 306 and is coupled to the frame system 302 of each sunshade assemblies 106 that makes up the sunshade array 306. The electrical raceway 402 includes an electrical output 404, which provides consolidated integration with a building's electrical system. As illustrated in FIGS. 4B, 8A, and 8B, the electrical raceway 402 includes an electrical path 403 that provides an electrical connection point 405 to the photovoltaic panels 304 and the electrical output 404 to building electrical system. In various implementations, the electrical path 403 may be for example, wire, signal-phase or multi-phase cable, busway, or another type of electrical pathway. The electrical raceway provides a structural attachment point for each of the photovoltaic panels 304 included in the sunshade array 306. Thus, each sunshade assembly 106 of the sunshade array 306 may be individually coupled or decoupled from the electrical raceway 402 without removal or disruption of the remaining sunshade systems in the sunshade array 306.

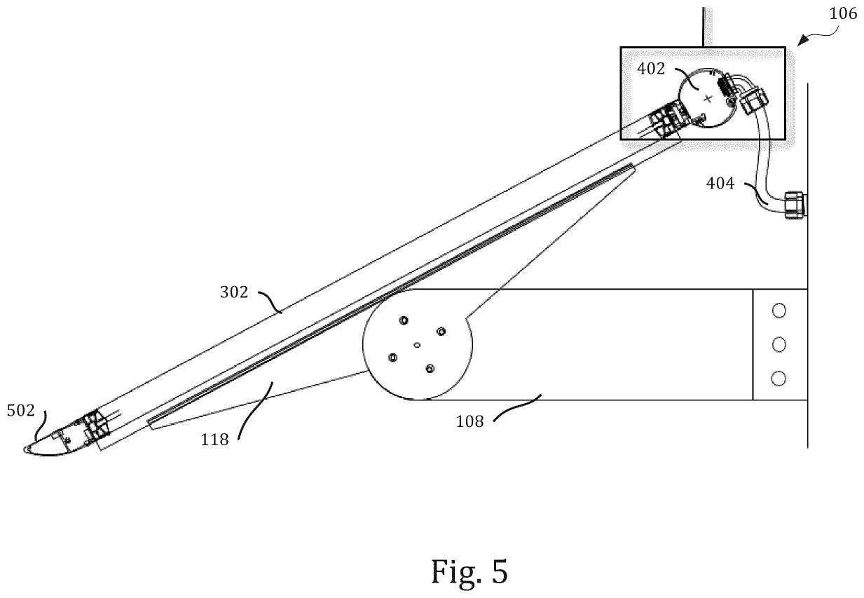

FIG. 5 is a side view of the example photovoltaic sunshade assembly 106 illustrating the electrical raceway 402. The support brackets 118 are disposed at an angle relative to the outriggers 108. In various implementations, the support brackets 118 may be movable relative to the outriggers 108. In other implementations, the support brackets 118 are fixed relative to the outriggers 108. The support brackets 118 are coupled to the frame system 302. In various implementations, an end cap 502 is coupled to a leading edge of the frame system 302. In the example illustrated in FIG. 5, the end cap 502 is an air foil; however, in other implementations, the end cap 502 could be, for example, square, bullnose, rounded, or any other shape. The electrical raceway 402 is coupled to an edge of the frame system 302 closest to the building; however, in other implementations, the electrical raceway 402 may be positioned in a different location. For example, in various implementations, a wiring junction could be disposed on any side of the frame system 302 and the wires could be passed through a hollow space in the center of frame members. In some implementations, the electrical raceway 402 may be coupled to a side of the frame system 302 that is opposite the end cap 502. The electrical raceway 402 includes an electrical output 404, which provides a consolidated integration with a building's electrical system. As will be discussed in greater detail below, the electrical raceway 402 provides an electrical connector for each of the photovoltaic panels 304 included in the sunshade array 306. As shown in FIGS. 8A and 8B, such an arrangement allows each sunshade assembly 106 of the sunshade array 306 to be individually coupled or decoupled from the electrical raceway 402 without removal or disruption of the remaining sunshade systems in the sunshade array 306. In some implementations, the electrical output 404 may be, for example, a flexible conduit, the frame system 302, and the photovoltaic panel 304 relative to the outriggers 108.

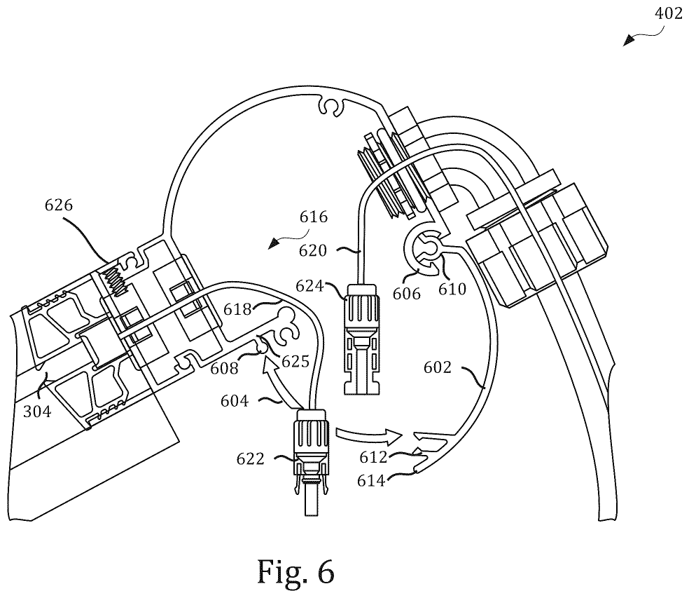

FIG. 6 is a cross-sectional detail view of the example electrical raceway 402 illustrating an access cover 602 in an open position. The electrical raceway 402 includes the access cover 602 that pivots between a closed position and an open position as illustrated by arrow 604. In the example shown in FIG. 6, the access cover 602 opens downwardly relative to the electrical raceway 402 so as to prevent infiltration of, for example, water into the electrical raceway 402.

In the example shown in FIG. 6, a hinge socket 606 is formed in a first edge of the electrical raceway 402. A friction nub 608 is formed in a second edge of the electrical raceway 402 opposite the hinge socket 606. A hinge pin 610 is formed in a first end of the access cover 602. The hinge pin 610 is received into the hinge socket 606 thereby enabling the access cover 602 to pivot between the closed position and the open position. A clip 612 is formed in a second end of the access cover 602. When the access cover 602 is in the closed position, the friction nub 608 is received into the clip 612 in a snap fit. Friction between the friction nub 608 and the clip 612 secures the access cover 602 in the closed position. In various implementations, the clip 612 may include one or more legs and the friction engagement between the friction nub 608 and the clip 612 may involve a single leg or multiple legs of the clip 612. When it is desired to pivot the access cover 602 to the open position, a flat tool such as, for example, a screwdriver, may be inserted under a tab 614 formed in the second end of the access cover 602. Application of pressure to the tab 614 overcomes the friction between the friction nub 608 and the clip 612, thereby allowing the clip 612 to disengage from the friction nub 608. The access cover 602 may then be moved to the open position.

In the example shown in FIG. 6, an electrical connector 616 is disposed in the electrical raceway 402. The electrical connector 616 includes a first electrical lead 618 that is coupled to the photovoltaic panel 304 (shown in FIG. 3) and a second electrical lead 620 that is coupled to the building's electrical system. In various implementations, the second electrical lead 620 may be coupled to the building's electrical system through the electrical path 403 shown in FIG. 4B. A first coupling 622 is disposed on the first electrical lead 618 and a second electrical coupling 624 is disposed on the second lead 620. In various implementations, a second lead 620 having the second electrical coupling 624 is provided for each sunshade assembly 106 contained in the sunshade array 306. During use, the electrical connector 616 allows the photovoltaic panel to be coupled and decoupled from the building's electrical system for repair, maintenance, cleaning, or replacement. Although not explicitly shown in the example illustrated in FIG. 6, multiple electrical connectors 616 may be utilized to facilitate modular connection of each photovoltaic panel 304 in a sunshade array 306. In various implementations, moving the access cover 602 to the open position facilitates access to the electrical connector 616. A wire shelf 625 is formed in an interior of the electrical raceway 402. In the example illustrated in FIG. 6, the wire shelf 625 is formed on a side of the electrical raceway 402 that is closest to the frame system 302; however, in other implementations, the wire shelf 625 may be located elsewhere within the electrical raceway 402 including on a side opposite the frame system 302 and closest to the building exterior wall system 102. During operation, the first electrical lead 618, the second electrical lead 620, the first coupling 622 and the second electrical coupling 624 are supported by the wire shelf 625. Such an arrangement prevents the first electrical lead 618, the second electrical lead 620, the first coupling 622 and the second electrical coupling 624 from resting on a bottom interior of the access cover 602 and prevents the first electrical lead 618, the second electrical lead 620, the first coupling 622 and the second electrical coupling 624 from resting in, for example, water if water should infiltrate the electrical raceway 402. In various implementations, the access cover 602 is divided into sections corresponding to each sunshade assembly 106. Thus, removal of or access to a sunshade assembly 106 requires opening of a shorter length of the access cover 602.

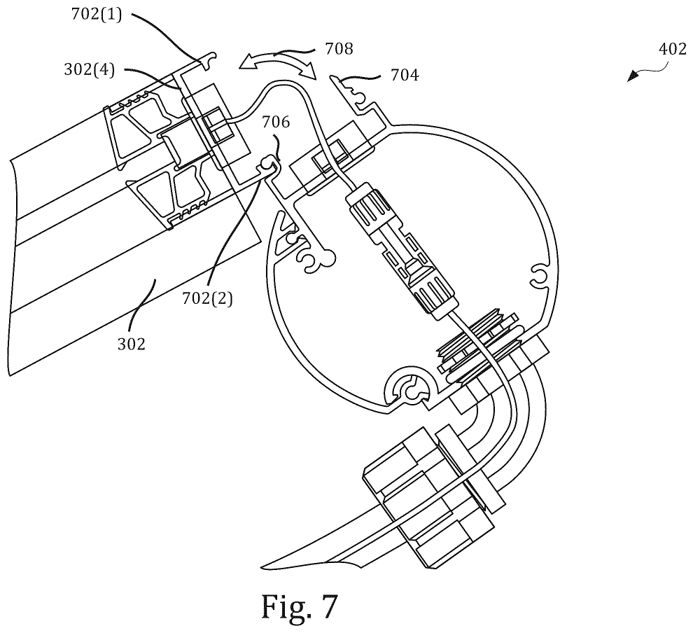

FIG. 7 is a view of the example electrical raceway 402 illustrating decoupling of the electrical raceway 402 from the frame system 302. The frame system 302 includes a pair of opposite disposed flanges (702(1), 702(2)) disposed on an outward-facing side of, for example, the fourth frame member 302(4). The electrical raceway 402 includes a first tongue 704 and a second tongue 706 extending from the electrical raceway 402 in a parallel fashion. When assembled to the frame system 302, the first tongue 704 and the second tongue 706 are received between the oppositely disposed flanges (702(1) and 702 (2)) and secured thereto in a snap-fit engagement. Thus, the example electrical raceway 402 provides multiple structural attachment points for multiple sunshade assemblies 106. Such an arrangement allows modular coupling and decoupling of the sunshade assembly 106 to the electrical raceway 402. Thus, replacement or repair of a single sunshade assembly 106 does not require removal of the entire sunshade array 306 or disruption of other sunshade systems in the sunshade array 306.

When it is desired to decouple the electrical raceway 402 from the frame system 302, the first tongue 704 is decoupled from the oppositely disposed flanges 702(1). This allows the electrical raceway to be rotated about the second tongue 706 in the direction illustrated by the arrow 708 and decoupled from the frame system 302. Such an arrangement facilitates removal of a single sunshade assembly 106 of the sunshade array 306 from the electrical raceway 402 for repair, maintenance, cleaning, or replacement. Thus, replacement or repair of a single sunshade assembly 106 does not require removal of the entire sunshade array 306 or disruption of other sunshade systems in the sunshade array 306.

FIG. 8A is a top view of an example photovoltaic array illustrating removal of a photovoltaic panel 304 and frame system 302 from support brackets 118. As illustrated, in various implementations, the frame system 302 and the photovoltaic panel 304 may be removed from the support brackets 118 and the electrical raceway 402 without disturbing other sunshade assemblies 106 in the sunshade array 306. FIG. 8C illustrates an example connection of the frame system 302 to the support bracket 118. The frame members 302(2) and 302(3) include a pocket 802 that receives a flange 804 that is formed on the support bracket 118. The interaction of the flange 804 and the pocket 802 allows the frame members 302(2) and 302(3) to be slidably received onto the support brackets 118. In various implementations, the frame member 302(2) and 302(3) may be secured with a fastener 806; however, in other implementations, the fastener 806 may be omitted.

FIG. 8B is a bottom view of an example sunshade array 306 illustrating removal of a sunshade assembly 106. In various implementations, a sunshade assembly 106 may be removed from the sunshade array 306 without disturbing other sunshade assemblies in the sunshade array. FIG. 8B illustrates that the outriggers 108 may be removed from the anchors 110 without the need to disturb the remaining sunshade assemblies 106 in the sunshade array 306.

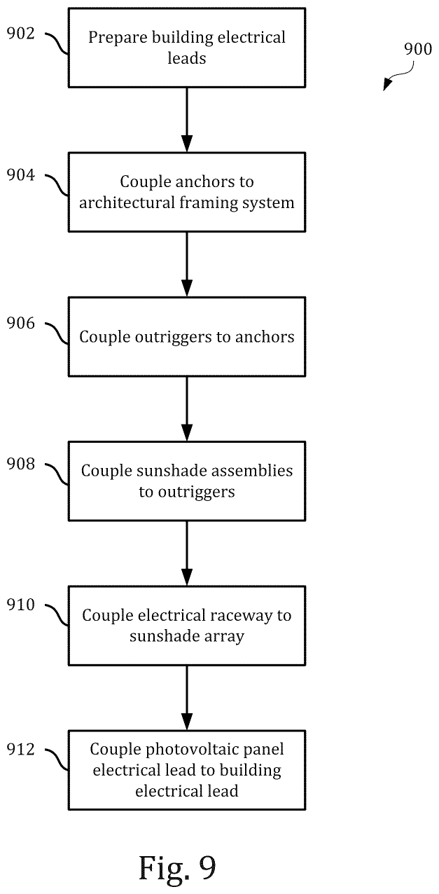

FIG. 9 is a flow diagram illustrating an example process 900 for installing a photovoltaic sunshade array. In various implementations, the sunshade array described in FIG. 9 is the sunshade array 306, which includes multiple sunshade assemblies 106 or another type of sunshade array. The example process 900 may include additional or different operations, and the operations may be performed in the order shown or in another order. In some cases, one or more operations may be repeated, omitted, or performed in another manner.

At 902, building electrical leads are prepared and positioned at or near an end of each sunshade array. In various implementations, the sunshade array is the sunshade array 306 illustrated in FIG. 3 or another sunshade array. At 904, anchors are coupled to an architectural framing system. In various implementations, the anchors are the anchors 110 illustrated in FIGS. 2A and 2B or another type of anchor. The architectural framing system may be the building exterior wall system 102 illustrated in FIG. 1 or another type of building exterior wall system.

At 906, outriggers are coupled to the anchors on the building exterior. In various implementations, the outriggers are the outriggers 108 described above or another type of outrigger and the building exterior includes the building exterior wall system 102 described above or another exterior wall system. In various implementations, the outriggers may be coupled to the building exterior using the anchor 110 described above. In various implementations, a pair of outriggers is coupled to the building exterior for each sunshade system included in the sunshade array.

At 908, multiple sunshade assemblies are coupled to the outriggers to produce a sunshade array. In various implementations, the sunshade assemblies may be, for example, the sunshade assemblies 106 described above or another type of sunshade assembly.

At 910, an electrical raceway is coupled to the sunshade array. In various implementations, the electrical raceway may be the electrical raceway 402 illustrated in FIG. 4A or another type of raceway. In various implementations, the frame system is coupled to the electrical raceway using a fastener such as, for example, the fastener 626 illustrated in FIG. 6 or another type of fastener. The electrical raceway facilitates attachment of multiple frame systems of sunshade systems in the sunshade array. In various implementations, the photovoltaic panels are received into the frame system and supported by the frame system.

At 912, the photovoltaic panels contained in the sunshade array are electrically coupled to an electrical system of the building. In various implementations, such an electrical connection is made using, for example, the electrical connector 616 illustrated in FIG. 6 or another type of electrical connection. The electrical connection is contained in the electrical raceway. In various implementations one electrical coupling such as, for example the second electrical coupling 624 is provided for each sunshade system in the sunshade array. In various implementations, the electrical raceway facilitates modular mechanical and electrical coupling and decoupling of sunshade systems of the sunshade array. Thus, individual sunshade systems may be removed or replaced as needed without disruption of remaining sunshade systems of the sunshade array.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

What is claimed is:

1. A sunshade array comprising:
a plurality of sunshade assemblies, each sunshade assembly comprising:
a frame system coupled to a building exterior;
a photovoltaic panel supported by the frame system; and
an electrical raceway coupled to the plurality of sunshade assemblies, the electrical raceway containing an electrical path having an electrical connection point to the photovoltaic panel and an electrical output to an electrical system of the building.

2. The sunshade array of claim 1, wherein each sunshade assembly is individually decoupled from the electrical raceway.

3. The sunshade array of claim 2, wherein a sunshade assembly is decoupled from the electrical raceway by removal of a fastener.

4. The sunshade array of claim 1, wherein the electrical raceway comprises a cover that is rotatable between a closed position and an open position, wherein the cover opens downwardly relative to the electrical raceway.

5. The sunshade array of claim 1, wherein the frame system is supported by a pair of outriggers that are coupled to the building exterior.

6. The sunshade array of claim 5, wherein each outrigger of the pair of outriggers are coupled to the building exterior by an anchor.

7. The sunshade array of claim 6, wherein the anchor receives a pin that extends inwardly from each outrigger of the pair of the outriggers.

8. The sunshade array of claim 5, wherein the frame system comprises a plurality of frame members disposed around the photovoltaic panel.

9. The sunshade array of claim 8, further comprising a pair of support brackets, the pair of support brackets being coupled to a support cross member and being coupled to respective outriggers of the pair of outriggers.

10. The sunshade array of claim 1, wherein the plurality of sunshade assemblies comprise a single row of sunshade assemblies.

11. The sunshade array of claim 1, wherein the plurality of sunshade assemblies is grouped in a linear fashion.

12. The sunshade array of claim 1, wherein the photovoltaic panel is mounted on a glass layer.

13. The sunshade array of claim 12, wherein the glass layer is clear glass, frosted glass, tinted glass, or glass having a variable opacity.

14. An electrical raceway for use with a photovoltaic sunshade array, the electrical raceway comprising:
a plurality of structural attachment points, each structural attachment point for coupling a sunshade assembly to the electrical raceway;
an electrical path comprising a plurality of electrical connection points for coupling to a photovoltaic panel of a sunshade assembly; and
an electrical output for coupling to an electrical system of a building, the electrical output being coupled to the electrical path.

15. The electrical raceway of claim 14, wherein the sunshade assembly is individually decoupled from the electrical raceway.

16. The electrical raceway of claim 14, comprising a cover that is rotatable between a closed position and an open position, wherein the cover opens downwardly relative to the electrical raceway.

17. The electrical raceway of claim 14, wherein the structural attachment point comprises a fastener.

18. The electrical raceway of claim 14, wherein the sunshade assembly comprises:
a pair of outriggers coupled to a building exterior; and
a frame system supported by the outriggers, the frame system having the photovoltaic panel disposed therein.

19. A method of installing a photovoltaic sunshade array, the method comprising:
coupling a frame system to a pair of outriggers that are coupled to a building exterior, the frame system containing a photovoltaic panel;
coupling the frame system to an electrical raceway; and
coupling a first electrical lead from the photovoltaic panel to a second electrical lead that is coupled to an electrical path that is integrated with an electrical system of the building, the first electrical lead and the second electrical lead being contained within the electrical raceway.

20. The method of claim 19, wherein the photovoltaic sunshade array comprises a plurality of sunshade assemblies.

21. The method of claim 20, wherein the plurality of sunshade assemblies comprise a single row of sunshades.

22. The method of claim 20, wherein the plurality of sunshade assemblies is linear.

23. The method of claim 19, wherein the steps are repeated for each sunshade assembly of the photovoltaic sunshade array.

24. The method of claim 19, wherein each sunshade assembly is individually decoupled from the electrical raceway.

25. The method of claim 24, wherein a sunshade assembly is decoupled from the electrical raceway by removal of a fastener.

26. The method of claim 19, wherein the electrical raceway comprises a cover that is rotatable between a closed position and an open position, wherein the cover opens downwardly relative to the electrical raceway.

27. The method of claim 19, wherein the frame system is supported by a pair of outriggers that are coupled to the building exterior.

28. The method of claim 27, wherein each outrigger of the pair of outriggers are secured to the building exterior by an anchor.

29. The method of claim 28, wherein the anchor receives a pin that extends inwardly from each outrigger of the pair of the outriggers.

30. The method of claim 29, wherein the frame system comprises a plurality of frame members disposed around the photovoltaic panel.

31. The method of claim 30, further comprising a pair of support brackets, the pair of support brackets being coupled to a support cross member and being coupled to respective outriggers of the pair of outriggers.

32. The method of claim 19, wherein the photovoltaic panel comprises a glass layer.

33. The method of claim 32, wherein the glass layer is clear glass, frosted glass, tinted glass, or glass having a variable opacity.
